(19) United States
(12) Patent Application Publication
(10) Pub. No.: US 2003/0233157 A1
(43) Pub. Date: Dec. 18, 2003

(54) Method of executing shuttle function cooperating with a multimedia program

(75) Inventor: Chung-Chih Tung, Taipei (TW)

Correspondence Address: QUINTERO LAW OFFICE, 1617 BROADWAY, 3RD FLOOR, SANTA MONICA, CA, 90404, US

(73) Assignee: Mitac Technology Corp.

(21) Appl. No.: 10/419,591

(22) Filed: Apr. 21, 2003

(30) Foreign Application Priority Data
Jul. 12, 2000 (TW) 89113828

(51) Int. Cl. G05B 19/42

(52) U.S. Cl. 700/87; 700/88

(57) ABSTRACT

A method of executing shuttle function cooperating with a multimedia program. In the present invention, a wheel mouse with a scroll page function is provided coupled to a computer, wherein an operating system of the computer outputs a first signal when the scroll page function is executed. The multimedia program detects wheel rotation of the mouse when detecting the first signal during execution of the multimedia program. The multimedia program executes the shuttle function to advance or review frames according to wheel motion of the mouse. In addition, the multimedia program executes corresponding operations when detecting other signals from the operating system.

### BACKGROUND OF THE INVENTION

1. Field of the Invention

The present invention relates to a method of advancing frames or reviewing frames, in particular to a method of executing shuttle function cooperating with a multimedia program using scroll page function provided by a wheel mouse.

2. Description of the Related Art

At present, computer users usually enjoy VCD, DVD, CD, MP3 and the like using multimedia programs. To advance frames or review frames, users need Fast Forward, Review, or shuttle functions. Conventional multimedia programs provide buttons or trackbars for these operations, however they are still not convenient, using mice to align pointers with buttons or trackbars and clicking.

Wheel mice, though, are widely used, and are very convenient, for scrolling through pages without moving the mouse or pointer.

### SUMMARY OF THE INVENTION

Accordingly, an object of the present invention is to provide a method of executing shuttle function cooperating with a multimedia program by the scroll page function of a wheel mouse, thereby advancing frames or reviewing frames, and thereby enhancing convenience for computer users.

In the method of the present invention, a wheel mouse with a scroll page function is provided coupled to a computer, wherein an operating system of the computer outputs a first signal when the scroll page function is executed. A multimedia program detects wheel rotation of the mouse when detecting the first signal during execution of the multimedia program. The multimedia program executes the shuttle function to advance or review frames according to wheel motion of the mouse. Also, the multimedia program executes corresponding operations when detecting other signals from the operating system.

A detailed description is given in the following embodiments with reference to the accompanying drawings.

### BRIEF DESCRIPTION OF THE DRAWINGS

The present invention can be more fully understood by reading the subsequent detailed description and examples with reference to the accompanying drawings, wherein:

FIG. 1 is a flowchart of the present invention.

### DETAILED DESCRIPTION OF THE INVENTION

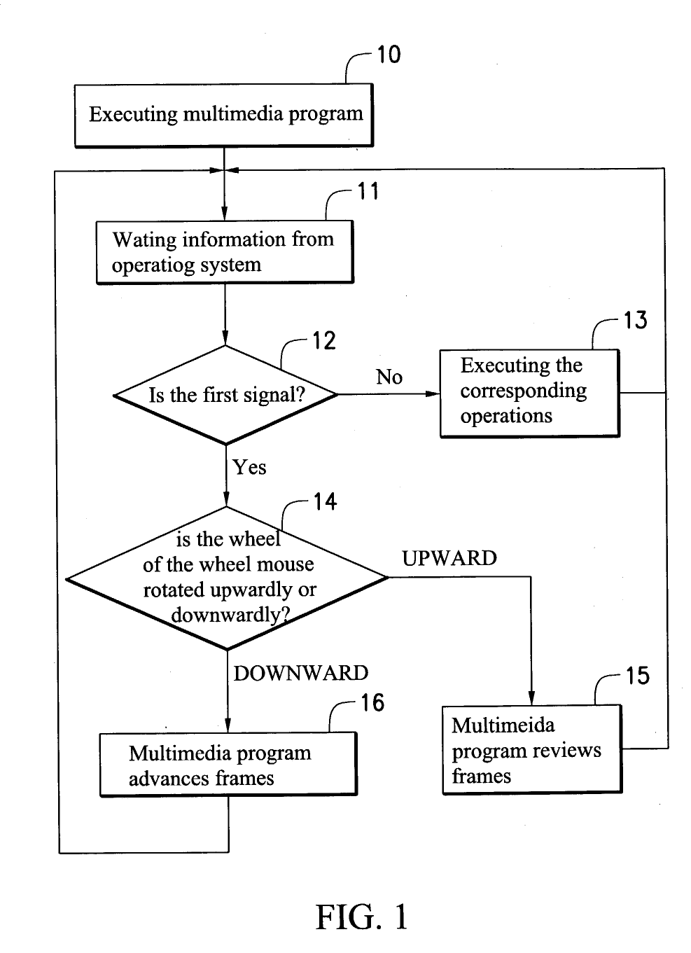

FIG. 1 is a flowchart of the present invention.

First, a wheel mouse is provided coupled to a computer, wherein the wheel mouse supports a scroll page function. The operating system of the computer outputs a, first signal WM_mousewheel when the scroll page function is executed. The wheel of the wheel mouse is rotated to control the scroll page function when the multimedia program is not executed. Furthermore, the wheel of the wheel mouse is rotated to trigger the multimedia program to execute the shuttle function thereof during execution of the multimedia program.

The operating system outputs corresponding information to trigger the multimedia program to execute corresponding operations if users input commands such as pause, stop, advance frames, and the like, during execution of the multimedia program. For example, in step 11, the multimedia program not only plays a digital video disc but also receives information from the operating system after executing the multimedia program (step 10).

In step 12, the first signal WM_mousewheel from the computer is detected, indicating the user has rotated the wheel and wishes to execute the shuttle function of the multimedia program. Thus, the multimedia program recognizes rotation of the wheel of the wheel mouse in step 14.

The multimedia program detects upward rotation of the mouse wheel, indicating that the user wishes to review, thus the multimedia program reviews frames in step 15.

The multimedia program detects downward rotation of the mouse wheel, indicating that the user wishes to advance, thus the multimedia program advances frames in step 16.

In step 13, the multimedia program executes the corresponding operations when detecting other information from the operating system without the first signal WM_mousewheel during execution of the multimedia program.

Therefore, the present invention can advance frames or review frames (shuttle function) by rotating the wheel of the wheel mouse during execution of the multimedia program. Compared to conventional applications requiring alignment of the mouse pointer with onscreen buttons or trackbars and clicking thereon, the present invention is considerably more convenient.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of executing shuttle function cooperating with a multimedia program, comprising:
providing a wheel mouse with a scroll page function coupled to a computer, wherein an operating system of the computer outputs a first signal when the scroll page function of the wheel mouse is executed; and
executing the multimedia program, wherein the multimedia program detects wheel rotation of the mouse when detecting the first signal during execution of the multimedia program, the multimedia program executes a shuttle function to advance frames or review frames according to the detected wheel removal, and the multimedia program executes corresponding operations when detecting other signals from the operating system.

2. The method as claimed in claim 1, wherein the multimedia program executes the shuttle function to advance frames when the wheel of the wheel mouse is rotated downwardly, and the multimedia program executes the shuttle function to review frames when the wheel of the wheel mouse is rotated upwardly.

3. The method as claimed in claim 1, wherein the wheel mouse executes the scroll page function when the wheel of the wheel mouse is rotated when the multimedia program is not active, and the wheel mouse triggers the multimedia program to execute shuttle function according to wheel motion of the mouse during execution of the multimedia program.
